(19) United States
(12) Patent Application Publication
(10) Pub. No.: US 2009/0250190 A1
(43) Pub. Date: Oct. 8, 2009

(54) HEATING FOR A TRANSPORT REFRIGERATION UNIT OPERATING IN COLD AMBIENTS

(75) Inventor: David R. Siegenthaler, Verona, NY (US)

Correspondence Address: William W. Habelt, 250 South Clinton Street, Suite 300, Syracuse, 13202, omitted

(73) Assignee: Carrier Corporation, Farmington, CT (US)

(21) Appl. No.: 12/306,386

(22) PCT Filed: Jul. 20, 2006
(86) PCT No.: PCT/US06/28255

§ 371 Date: Dec. 23, 2008

(51) Int. Cl. B60H 3/00; F25B 27/02; F25D 17/06; B60H 1/32; F28F 13/12

(52) U.S. Cl. 165/42; 62/238.7; 62/89; 62/239; 165/121

(57) ABSTRACT

A transport refrigeration system, which uses the heat of compression to selectively provide heat to a cargo space by way of the evaporator coil, is provided with enhanced heating capacity during lower ambient conditions by causing the heat from an engine radiator to flow over the condenser coil to thereby increase the condensing pressure and temperature and thereby increase the heat of compression and the heat being provided to the space. Provision is also made to cause the hot air from the engine itself to flow over the engine radiator and the condenser coil to further enhance the heating capacity. Various damper and shutter arrangements are also provided as alternative embodiments.

### BACKGROUND OF THE INVENTION

This invention relates generally to refrigeration systems and, more particularly to transport refrigeration systems operating in low temperature ambient conditions.

For the transportation of goods that are required to be kept cold or frozen, vehicles such as trucks, trailers, rail cars, or refrigerated containers are provided with a refrigeration system which interfaces with the cargo space to cool the cargo down to a predetermined temperature. During periods in which the vehicle is located in an area of relatively low ambient temperature conditions, the temperature within the cargo space may fall to undesirable low temperatures such that the cargo could be damaged. Accordingly, it is necessary to provide heat to the internal cargo space so as to prevent the temperatures from falling to such levels.

One method that has been used to provide heat to a cargo container is that of using the refrigerant heat of compression. However, in extremely cold ambients there is a minimal heat of compression that can be generated because much of the heat is lost to the surrounding atmosphere in the condenser and interconnecting piping. If the heat of compression is insufficient to overcome the lower ambient temperature conditions damage to the cargo may result.

A transport refrigeration unit normally includes a diesel engine for driving the compressor of the system.

The diesel engine normally has a liquid coolant system that includes a radiator for cooling the liquid by way of a liquid-to-air heat exchanger or radiator. In this way, the heat from the engine is passed to ambient by way of the radiator. It is common to place the radiator adjacent to the condenser with a single fan to draw cooling air first through the condenser and then through the radiator after which it passes to ambient.

### SUMMARY OF THE INVENTION

Briefly, in accordance with one aspect of the invention, during periods in which the refrigeration system is operating in very low ambient temperature conditions, the normal heating system is supplemented by a heating system in which waste heat from the engine radiator is used to increase the condensing pressure and temperature so as to thereby increase the heat of compression and the amount of heat that is available to maintain the temperature of the cargo.

By another aspect of the invention, a fan, which normally operates to draw cooling air first through a condenser coil and then through the radiator coil, is operated in reverse during the heating cycle to cause air to pass over the radiator coil and then over the condenser coil to thereby increase the heat of compression in the system.

By yet another aspect of the invention, in addition to the heat from the radiator coil, the heat from the engine is caused to flow over the condenser coil to thereby further increase the heat of compression on the system.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a schematic illustration of a transport refrigeration system operating in the cooling mode in accordance with the prior art.

FIG. 2 is a schematic illustration of a transport refrigeration system operating in the heating mode in accordance with the prior art.

FIG. 3 is a schematic illustration of a side view showing the airflow through the system during a cooling mode in accordance with the present invention.

FIG. 4 is a schematic illustration of a side view showing the airflow through the system during the heating cycle in accordance with the present invention.

FIG. 5 is a side view of an alternative embodiment thereof.

FIG. 6 is a schematic side view of the airflow during a cooling mode in accordance with an alternative embodiment.

FIG. 7 is a schematic side view of the heating mode in accordance with such an alternative approach.

FIG. 8 is a schematic illustration of another alternative embodiment of the invention.

### DESCRIPTION OF THE PREFERRED EMBODIMENT

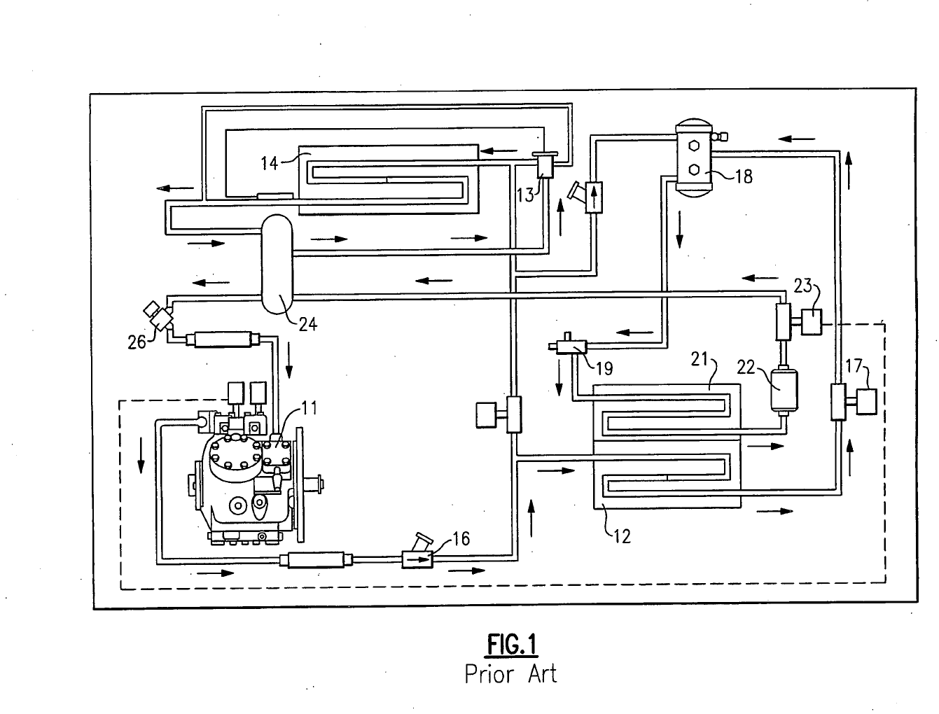

Referring now to FIG. 1, there is shown a conventional transport refrigeration system that includes the primary components of a compressor 11, a condenser 12, an expansion valve 13 and an evaporator 14, all connected in serial flow relationship to operate as a vapor compression refrigeration system in a normal manner.

The compressor 14 raises the pressure and the temperature of the refrigerant and forces it through the discharge check valve 16 and into the condenser tubes. The condenser fan circulates surrounding air over the outside of the condenser tubes. The tubes have fins designed to improve the transfer of heat from the refrigerant gas to the air. This removal of heat causes the refrigerant to liquefy. Liquid refrigerant leaves the condenser 12 and flows through the solenoid valve 17 (normally open) and to the receiver 18.

The receiver 18 stores the additional charge necessary for low ambient operation and for the heating and defrost modes of operation.

The refrigerant leaves the receiver 18 and flows through the manual liquid line service valve 19 to the subcooler 21. The subcooler 21 occupies a portion of the main condensing coil surface and gives off farther heat to the passing air.

The refrigerant then flows through a filter-drier 22 where an absorbent keeps the refrigerant clean and dry, and then to the electrically controlled liquid line solenoid valve 23, which, when open, allows for the flow of liquid refrigerant to the “liquid/suction” heat exchanger 24 where the liquid is further reduced in temperature by giving off some of its heat to the suction gas. The liquid then flows to the expansion valve 13 which is preferably an externally equalized thermostatic expansion valve which reduces the pressure of the liquid and meters the flow of liquid refrigerant to the evaporator 14 to obtain maximum use of the evaporator 14 heat transfer surface.

The refrigerant pressure drop caused by the expansion valve is accompanied by a drop in temperature such that the low pressure, low temperature fluid that flows into the evaporator tubes is colder than the air that is circulated over the evaporator tubes by the evaporator fan. The evaporator tubes have aluminum fins to increase heat transfer; therefore heat is removed from the air circulated over the evaporator. This cold air is circulated throughout the box to maintain the cargo at the desired temperature.

The transfer of heat from the air to the low temperature liquid refrigerant causes the liquid to vaporize. This low temperature, low pressure vapor passes through the “suction line/liquid line” heat exchanger 24 where it absorbs more heat from the high pressure/high temperature liquid and then returns to the compressor 11 through the suction modulation valve 26. The suction modulation valve 26 controls the compressor suction pressure, thereby matching the compressor capacity to the load.

While the primary concern with a transport refrigeration system is with the cooling mode of operation, it should be recognized that in certain seasons and localities the ambient temperatures are lower than the desired temperature for the internal confines of the box. Accordingly, it is necessary to provide heat to the box during these periods in order to prevent the cargo from being exposed to temperatures below the desired temperatures. Further, there are times when operating in the cooling mode that the evaporator coil has a frost buildup thereon that needs to be removed in order to continue to operate efficiently. This is accomplished by a defrosting process. Both the heating and defrosting is commonly accomplished by use of the “heat of compression” of the system. That is, when vapor is compressed to a high pressure and temperature in the compressor 11, the mechanical energy necessary to operate the compressor 11 is transferred to the gas as it is being compressed. This energy is referred to as the “heat of compression” and is used as a source of heat during the heating cycle.

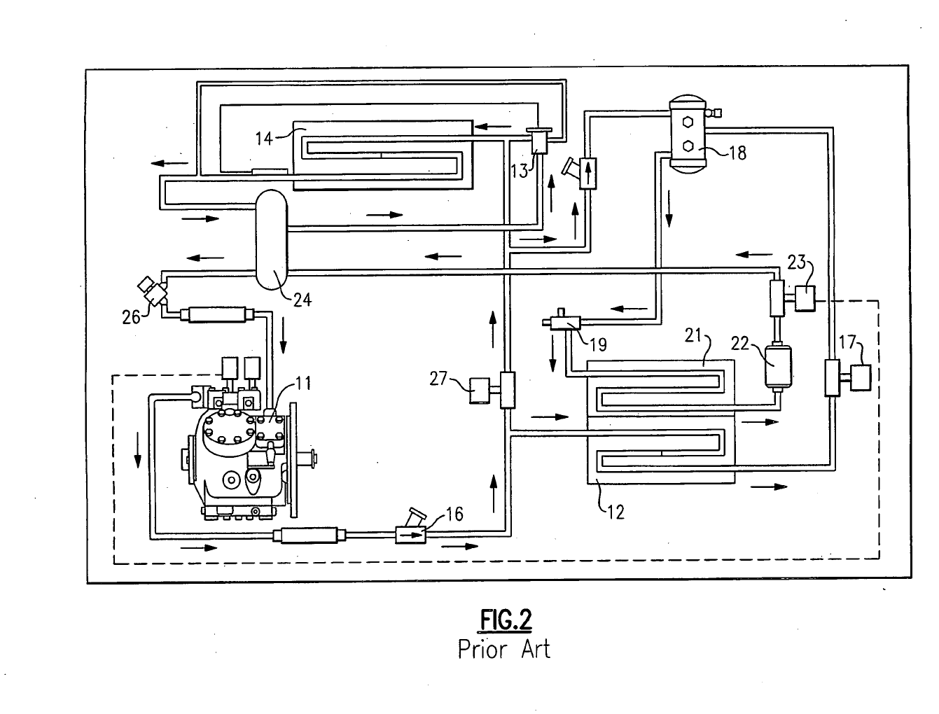

Referring to FIG. 2, when the unit controller calls for heating, the hot gas solenoid valve 27 opens and the condenser pressure control solenoid valve 17 closes. The condenser coil 12 then fills with refrigerant, and hot gas from the compressor 11 enters the evaporator 17. Also the liquid line solenoid valve 23 will remain energized (valve open) until the compressor discharge pressure increases to a pre-determined setting in the microprocessor. The microprocessor de-energizes the liquid line solenoid valve 23 and the valve closes to stop the flow of refrigerant to the expansion valve 13. When additional heating capacity is required the microprocessor opens the liquid line solenoid valve 23 to allow additional refrigerant to be metered into the hot gas cycle through the expansion valve 13.

The function of the hot gas bypass line 28 is to raise the receiver pressure when the ambient temperature is low (below −17.8° C./0° F.) so that refrigerant flows from the receiver 18 to the evaporator 14 when needed.

The applicants have recognized that in cold ambients, there is a minimal heat of compression that can be generated and this heat of compression may not be sufficient to provide the necessary heat to maintain the desired temperature in the box. It is therefore desirable to provide additional heat during these periods.

The compressor 14 is traditionally driven by an internal combustion engine and preferably a diesel engine. Such an engine requires some method of cooling so as to prevent excessive temperatures therein. This is normally accomplished by way of a radiator with liquid coolant passing through the engine and through the radiator where it is exposed to the flow of air therethrough for the cooling of the coolant.

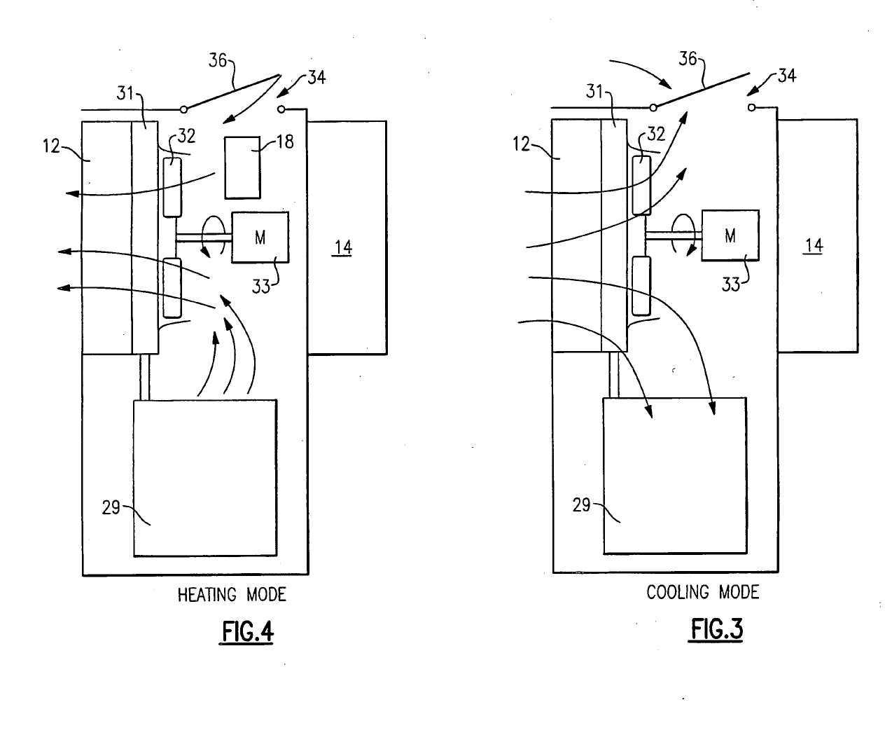

Referring now to FIG. 3, the relative placement of the engine 29 and its fluidly connected radiator 31 is shown in relation to the condenser coil 12 and the evaporator coil 14. As will be seen, the radiator coil 13 is located directly behind the condenser coil 12 such that when the condenser fan 32 is driven by the motor 33, the cooling air is caused to pass first through the condenser coil 12 and then through the radiator 31. A portion of the air then passes over the engine 29 as shown, and a portion passes out the opening 34 to ambient. A damper 36 may be provided to be used in a manner to be described hereinafter.

In order to boost the heat of compression during low ambient conditions, it is the intent of the present invention to use the heat that is rejected by the engine radiator 31 to provide an additional heat source for the purpose. This is 12 such that the warmer air being re-circulated into the condenser inlet air stream is used to boost the condensing pressure and temperature. Higher pressure leads to the compressor 11 producing more heat of compression, and therefore more heat can be generated to maintain cargo temperature.

In addition to the waste heat from the radiator, the relative position of the components as shown in FIG. 4 also allows heat from the engine 29 to be drawn-in by the fan 32 and passed to the radiator 31 and the condenser coil 12 to thereby further boost heat performance of the system.

Although the damper 36 as shown in FIGS. 3 and 4 is in the open position, it may be moved to a closed position for the purpose of directing warmer air into the radiator and condenser that has circulated past the warm engine to further raise condensing temperature and pressure, as opposed to just pulling colder air from the outside ambient.

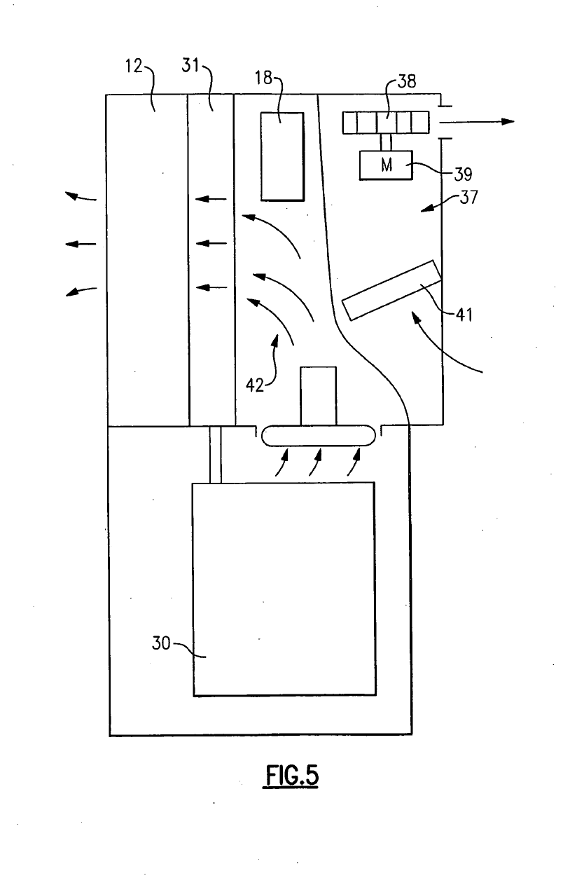

An alternative embodiment is shown in FIG. 5 wherein, because of packaging constraints, there is a minimum depth available for the unit. Accordingly, the evaporator section 37 has a dedicated fan 38 and drive motor 39 to circulate air through the evaporator coil 41. The condenser fan rather than being centrally located in the space 42, is located at the lower end thereof such that the motor 43 is located in the space 42 and the fan 44 is located between the space 42 and the space occupied by the engine compartment which includes the engine, generator and compressor shown at 30.

In operation during the heating process, the fan is operated in a direction such that the hot air from the engine compartment flows into the space 42 and through the radiator 31 and the condenser 12 so as to raise the condensing pressure in the manner as described hereinabove. In the cooling mode, the fan 44 is operated in the opposite direction such that the air flows first through the condenser 12 the radiator 31, the space 42 and then through the engine compartment.

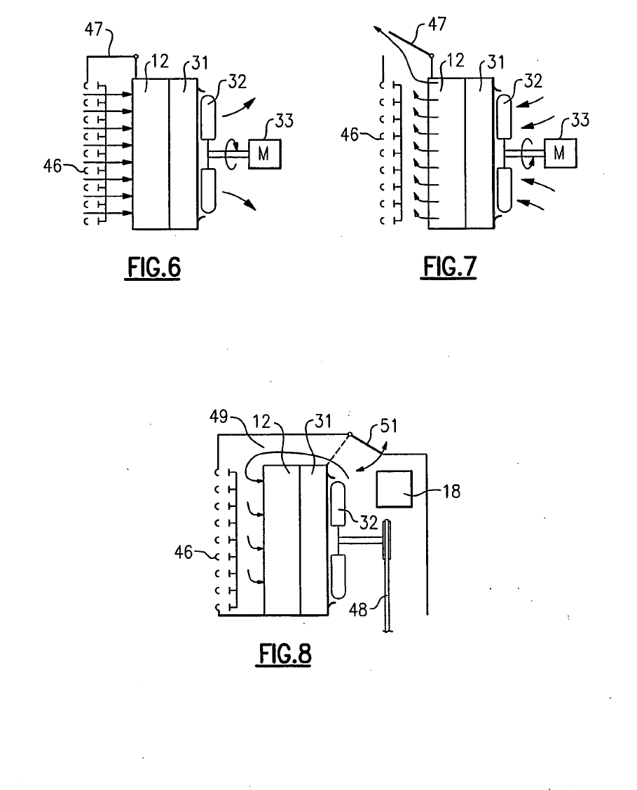

Referring now to FIGS. 6 and 7, an alternative embodiment is shown to include a plurality of shutters 46 and a damper 47 as shown. During operation in the cooling mode, the fan motor 33 is driving the fan 32 in a direction such that the air is pulled through the condenser 12 and the radiator 31, and the shutters 46 are open such that the air passes through them, through the condenser 12 and through the radiator 31. The damper 47 is in the closed position as shown.

During operation in the heating mode, the shutters 46 are closed and the damper 47 is open as shown. The fan motor 33 rotates the fan 32 in a blow through direction such that the air then passes first through the radiator 31, then through the condenser 12 and out the opening of the open damper 47 as shown. These additional dampers serve to block air from entering the condenser and radiator from the undesired direction that opposes the airflow path described above when the refrigeration unit is being transported.

A further alternative approach is shown in FIG. 8 wherein the fan 32 is driven by a belt 48 and is unidirectional. It is thus necessary to provide other means of reversing the direction of flow when changing from the cooling to the heating mode. For that purpose, an air recirculation passageway 49 is provided at one end of the unit as shown. Also provided is a gate 51 which is open (as shown in solid line) during the heating mode and closed (as shown in dashed line) during the cooling mode. Thus, during the cooling mode of operation, the air flows from the fan into the air circulation passageway 49 and then, with the shutters 46 in the closed position, the air passes through the condenser coil 12 and through the radiator 31.

During the cooling mode of operation, the gate 51 is in the closed position and the shutters 46 are in the open position such that the air passes first through the condenser coil 12 and then through the radiator 31, and out through the open shutters 51. In heating mode the fan direction can't be reversed with a belt drive approach, so air is directed into passageway 49 and recirculated to the condenser.

We claim:

1. A transport refrigeration system of the type having an engine driven compressor and having a fan, a condenser coil and a radiator coil in serial flow relationship such that during the cooling mode of operation the fan cause the air to flow through the condenser coil and then through the radiator coil, comprising:
apparatus for reversing the flow of air during a heating mode of operation such that the air is caused to flow first through the radiator coil and then through the condenser coil such that the condenser temperature and pressure is raised.

2. A transport refrigeration system as set forth in claim 1 wherein said flow reversing apparatus comprises an apparatus for reversing the direction of the fan.

3. A transport refrigeration system as set forth in claim 1 wherein said engine is disposed near said radiator coil and further wherein said flow reversing apparatus causes the air to flow such that the heat from the engine passes first through said radiator coil and then through said condensing coil.

4. A transport refrigeration system as set forth in claim 1 and including at least one shutter disposed adjacent said condenser coil and adapted to be open during cooling mode of operation and closed during heating mode of operation.

5. A transport refrigeration system as set forth in claim 4 and further including a damper disposed adjacent said condenser coil and adapted to be closed during the cooling mode of operation and open during the heating mode of operation.

6. A transport refrigeration system as set forth in claim 1 wherein said flow reversing apparatus comprises an air recirculation passageway and associated gate, wherein during cooling mode of operation, the gate is open and the air is caused to flow from the fan into the air recirculation passageway, through the condenser coil and then through the radiator coil, and during heating modes of operation, the gate is closed and the air from the fan passes first through the radiator and then through the condenser coil.

7. A method of increasing the heating capacity of a transport refrigeration system during low ambient temperature conditions the transport refrigeration system being of the type having an engine driven compressor and having a fan, a condenser coil and a radiator coil in serial flow relationship such that during the cooling mode of operation the fan causes the air to flow through the condenser coil and then through the radiator coil comprising the steps of:
reversing the flow of air such that the air is caused to flow first through the radiator coil and then through the condenser coil such that the condenser coil temperature and pressure is increased.

8. A method as set forth in claim 7 wherein said reversing step is accomplished by way of a reversible fan.

9. A method as set forth in claim 7 and including the further step of circulating air over said engine such that the heat from said engine flows first over said radiator coil and then through said condenser coil.

10. A method as set forth in claim 7 and including the step of providing shutters adjacent said condenser coil, with said shutters being adapted to be open during the cooling mode of operation and closed during the heating mode of operation.

11. A method as set forth in claim 10 and including the step of providing a damper near said condenser coil, with said damper being adapted to be closed during the cooling mode of operation and open during the heating mode of operation.

12. A method as set forth in claim 7 wherein said step of reversing the flow of air is accomplished by way of an air circulation passageway and an associated gate, with the gate being open during periods of cooling such that the air passes through said air recirculation passageway, through said condenser coil and said radiator, and during the heating mode of operation the gate is closed and the air passes first through said radiator coil and then through said condenser coil.

13. Heating apparatus for a transport refrigeration system of the type that is mounted on a cargo container and has a compressor, a condenser, an expansion device and an evaporator connected in serial flow relationship, with the evaporator selectively providing either cooling or heating to the cargo container comprising:
a motor/generator set that includes an internal combustion engine for driving the generator which, in turn, provides electrical power to the refrigeration system, said internal combustion engine having a radiator for exchanging heat from a coolant in said engine to ambient air being circulated over said radiator; and
apparatus for conducting the flow of heated air from said radiator to an inlet of said of condenser so as to increase the temperature of the air flowing over the condenser and thereby increase the condensing temperature and pressure.

14. Heating apparatus as set forth in claim 13 wherein said flow conducting apparatus comprises a reversible fan.

15. A method of boosting the heating capacity of a transport refrigeration system for cooling a container and having a condenser and a compressor, with the heat of compression being applied to heat the container during certain low ambient conditions, comprising the steps of:
providing a motor/generator set that includes a liquid cooled internal combustion engine and a radiator for cooling the liquid by the transfer of heat to air passing over the radiator; and
channeling the flow of heated air from the radiator to an inlet of the condenser to increase the condensing pressure and temperature so as to thereby increase the refrigerant heat of compression and the resultant heat being provided to the container.

16. A method as set forth in claim 15 and including the further step of channeling the flow of heated air from the internal combustion engine to flow first over the radiator and then over said condenser to increase the condensing pressure and temperature thereof.
